(19) United States
(12) Patent Application Publication
(10) Pub. No.: US 2007/0242309 A1
(43) Pub. Date: Oct. 18, 2007

(54) METHOD AND APPARATUS FOR GENERATING XHTML DATA

(75) Inventor: Sung-won CHAE, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/684,872

(22) Filed: Mar. 12, 2007

Related U.S. Application Data
(60) Provisional application No. 60/791,423, filed on Apr. 13, 2006.

(30) Foreign Application Priority Data
May 12, 2006 (KR) 2006-43133

(51) Int. Cl. G06K 15/02

(52) U.S. Cl. 358/2.1

(57) ABSTRACT

A method of generating extensible hypertext markup language (XHTML) data includes setting printing-related options in relation to one or more image data items desired to be printed; generating XHTML extension data to be inserted into XHTML basic data prepared in advance according to the set printing-related options; and generating XHTML printing data by inserting the XHTML extension data into the XHTML basic data.

### CROSS-REFERENCE TO RELATED APPLICATIONS

This application claims the benefit of U.S. Provisional Patent Application No. 60/791,423 filed on Apr. 13, 2006, in the U.S. Patent and Trademark Office, and Korean Patent Application No. 10-2006-0043133 filed on May 12, 2006, in the Korean Intellectual Property Office, the disclosures of which are incorporated herein by reference in their entirety.

### BACKGROUND OF THE INVENTION

1. Field of the Invention

An aspect of the invention relates to extensible hypertext markup language (XHTML)-Print printing data, and more particularly to a method and apparatus for generating XHTML-Print printing data in which XHTML-Print extension data is generated corresponding to contents set by a user, and by inserting the generated XHTML-Printing extension data into XHTML-Print basic data prepared in advance, XHTML-Print printing data is generated according to the intention of the user.

2. Description of the Related Art

When image data stored in a terminal is desired to be printed through an image forming apparatus connected to the terminal through a network, the terminal generates XHTML-Print printing data including the image data to be printed, and transmits the generated XHTML-Print printing data to an image forming apparatus. In this case, the image forming apparatus recognizes the transmitted XHTML-Print printing data and prints the image data.

However, the number of templates provided by a terminal is limited. Here, a template is a means to determine the type of a matrix in which one or more images are to be printed.

Accordingly, since a conventional apparatus for generating XHTML-Print printing data implemented in a terminal generates XHTML-Print printing data according to a limited number of templates, XHTML-Print printing data that can be generated is limited.

### SUMMARY OF THE INVENTION

An aspect of the invention provides a method of generating XHTML-Print printing data in which XHTML-Print extension data is generated according to contents set by a user, and by inserting the generated XHTML-Printing extension data into XHTML-Print basic data prepared in advance, XHTML-Print printing data is generated according to the intention of the user.

Another aspect of the invention provides an apparatus for generating XHTML-Print printing data which performs the above method of generating XHTML-Print printing data.

Another aspect of the invention provides a computer-readable medium encoded with processing instructions for implementing the above method of generating XHTML-Print printing data performed by a computer.

According to an aspect of the invention, there is provided a method of generating extensible hypertext markup language (XHTML) data including setting printing-related options in relation to one or more image data items desired to be printed; generating XHTML extension data to be inserted into XHTML basic data prepared in advance according to the set printing-related options; and generating XHTML printing data by inserting the XHTML extension data into the XHTML basic data.

According to another aspect of the invention, there is provided an apparatus for generating extensible hypertext markup language (XHTML) data including an XHTML data setting unit that sets printing-related options in relation to one or more image data items desired to be printed; an XHTML basic data storage unit that stores XHTML basic data to be included in XHTML printing data; an XHTML extension data generation unit that generates XHTML extension data to be inserted into the XHTML basic data according to the set printing-related options; and an XHTML printing data generation unit that generates the XHTML printing data by reading the stored XHTML basic data and inserting the XHTML extension data generated by the XHTML extension data generation unit into the read XHTML basic data.

According to another aspect of the invention, there is provided a computer-readable medium encoded with processing instructions for implementing a method of generating extensible hypertext markup language (XHTML) data performed by a computer, the method including setting printing-related options in relation to one or more image data items desired to be printed; generating XHTML extension data to be inserted into XHTML basic data prepared in advance according to the set printing-related options; and generating XHTML printing data by inserting the XHTML extension data into the XHTML basic data.

According to another aspect of the invention, there is provided a method of generating extensible hypertext markup language (XHTML) data including setting at least one printing-related option specifying how at least one image data item is to be printed; generating XHTML extension data containing instructions on how to print the at least one image data item based on the set at least one printing-related option; and generating XHTML printing data for printing the at least one image data item by inserting the XHTML extension data into XHTML basic data.

According to another aspect of the invention, there is provided an apparatus for generating extensible hypertext markup language (XHTML) data including a printing data setting unit that sets at least one printing-related option specifying how at least one image data item is to be printed; an XHTML extension data generation unit that generates XHTML extension data containing instructions on how to print the at least one image data item based on the set at least one printing-related option; and an XHTML printing data generation unit that generates XHTML printing data for printing the at least one image data item by inserting the XHTML extension data into XHTML basic data.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the invention will become apparent and more readily appreciated from the following description of embodiments of the invention, taken in conjunction with the accompanying drawings of which:

FIG. 1 is a block diagram of an apparatus for generating XHTML-Print printing data according to an aspect of the invention;

FIG. 2 is a diagram of printer paper, cells, and images according to an aspect of the invention;

FIGS. 3A through 3P are figures for explaining a principle of generating XHTML-Print printing data according to an aspect of the invention;

FIGS. 4A through 4C are figures for explaining a principle of generating XHTML-Print printing data according to another aspect of the invention;

FIGS. 5A through 5C are figures for explaining a principle of generating XHTML-Print printing data according to another aspect of the invention;

FIG. 6 is a flowchart of a method of generating XHTML-Print printing data according to an aspect of the invention; and

FIG. 7 is a detailed flowchart of operation 610 of FIG. 6 according to an aspect of the invention.

### DETAILED DESCRIPTION OF THE EMBODIMENTS

Reference will now be made in detail to embodiments of the invention, examples of which are illustrated in the accompanying drawings, wherein like reference numerals refer to like elements throughout. The embodiments are described in detail below in order to explain the invention by referring to the figures.

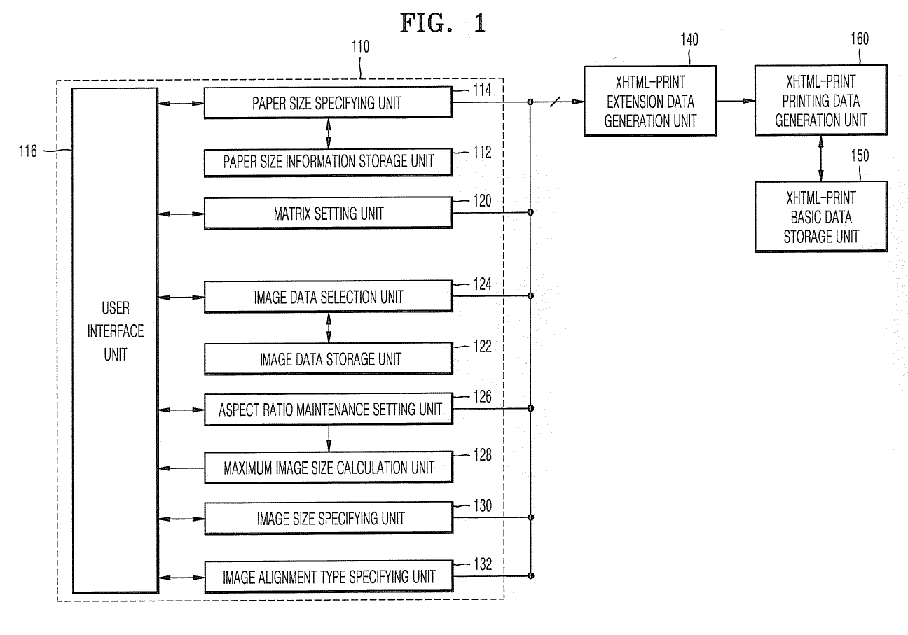

FIG. 1 is a block diagram of an apparatus for generating XHTML-Print printing data according to an aspect of the invention. The apparatus includes an XHTML-Print printing data setting unit 110, an XHTML-Print extension data generation unit 140, an XHTML-Print basic data storage unit 150, and an XHTML-Print printing data generation unit 160.

According to an aspect of the invention, XHTML-Print basic data, XHTML-Print extension data, and XHTML-Print printing data are all XHTML-Print data, but it will be readily understood by a person skilled in the art that techniques applied to XHTML-Print data as described below can also be applied to XHTML data or data expressed in another markup language.

The XHTML-Print printing data setting unit 110 through the XHTML-Print printing data generation unit 160 are all included in a terminal, and an image forming apparatus is connected to the terminal through wired or wireless means. According to an aspect of the invention, the image forming apparatus can print XHTML-Print printing data. Examples of the terminal include a mobile phone, a digital camera, and a personal digital assistant (PDA). Also, examples of the image forming apparatus include a printer and a multi-function peripheral (MFP) having a printer function.

The XHTML-Print printing data setting unit 110 sets printing-related options to determine how to print one or more image data items desired to be printed by the image forming apparatus. Examples of the printing-related options may include the size of printer paper on which the XHTML-Print printing data is to be printed; the numbers of rows and columns in which one or more image data items are to be printed; which image data item or items are to be printed; whether to maintain the aspect ratio (i.e., the height to width ratio) of selected image data items when the image data items desired to be printed are printed; in what size the image data items selected to be printed are printed; and how to align image data items selected to be printed. The term “paper” used in this application refers to any printing medium on which the XHTML-Print printing data can be printed, and is not limited specifically to paper per se. Examples of such printing media are copy paper, photographic paper, photographic film, transparencies, canvas, cloth, wood, metal, ceramic, brick, concrete, or any other suitable medium.

The XHTML-Print printing data setting unit 110 includes a paper size information storage unit 112, a paper size specifying unit 114, a user interface unit 116, a matrix setting unit 120, an image data storage unit 122, an image data selection unit 124, an aspect ratio maintenance setting unit 126, a maximum image size calculation unit 128, an image size specifying unit 130, and an image alignment type specifying unit 132.

The paper size information storage unit 112 stores paper size information. Here, the paper size information is information on available sizes of printer paper on which XHTML-Print printing data is printed.

The paper size specifying unit 114 commands the user interface unit 116 to display the paper size information stored in the paper size information storage unit 112. In this case, the user interface unit 116 displays the stored paper size information. By doing so, the user can recognize what sizes of printer paper on which XHTML-Print printing data can be printed are available.

Then, the user may specify a desired paper size through the user interface unit 116, or by manipulating keys disposed on the terminal. By doing so, the paper size specifying unit 114 specifies the paper size selected by the user among the stored paper sizes. Also, the paper size specifying unit 114 reads information on the specified paper size from the stored paper size information, and outputs the read information on the specified paper size to the XHTML-Print extension data generation unit 140, which will be described later.

The matrix setting unit 120 sets a numbers of rows and columns on which one or more image data items are arranged. According to an instruction from the matrix setting unit 120, the user interface unit 116 displays a window for the user to request setting of a desired numbers of rows and columns. Then, the user may set the desired numbers of rows and columns through the user interface unit 116, or by manipulating keys disposed on the terminal. By doing so, the matrix setting unit 120 sets the numbers of rows and columns. Also, the matrix setting unit 120 lets the XHTML-Print extension data generation unit 140 recognize the set numbers of rows and columns.

The image data storage unit 122 stores one or more image data items.

The user interface unit 116 displays the stored image data items according to an instruction of the image data selection unit 124. By doing so, the user can recognize which image data items area stored in the terminal.

Then, the user may select one or more image data items desired to be printed through the user interface unit 116, or by manipulating keys disposed on the terminal. By doing so, the image data selection unit 124 can select one or more image data items desired to be printed among the stored image data items. Also, the image data selection unit 124 outputs the selected image data items to the XHTML-Print extension data generation unit 140.

The aspect ratio maintenance setting unit 126 sets whether to maintain the aspect ratio of the image of the selected image data item when the selected image data item is printed. To accomplish this, according to an instruction from the aspect ratio maintenance setting unit 126, the user interface unit 116 displays a window to request setting of whether to maintain the aspect ratio of the image of the selected image data item when the selected image data item is printed. Then, the user may set whether to maintain the aspect ratio of the image when the selected image data item is printed through the user interface unit 116, or by manipulating keys disposed on the terminal. By doing so, the aspect ratio maintenance setting unit 126 sets whether to maintain the aspect ratio of the image when the selected image data item is printed. Also, the aspect ratio maintenance setting unit 126 provides the setting indicating whether the aspect ratio of the image is to be maintained during printing to the XHTML-Print extension data generation unit 140. Alternatively, the aspect ratio maintenance setting unit 126 may be omitted from an XHTML-Print printing data setting unit 110 according to another aspect of the invention.

The maximum image size calculation unit 128 calculates a maximum image size when printing the selected image data item. If the aspect ratio maintenance setting unit 126 maintains the aspect ratio of the image, the calculated maximum image size may be less than the size of a cell. However, if the aspect ratio maintenance setting unit 126 does not maintain the aspect ratio of the image, the calculated maximum image size is the same as the size of a cell.

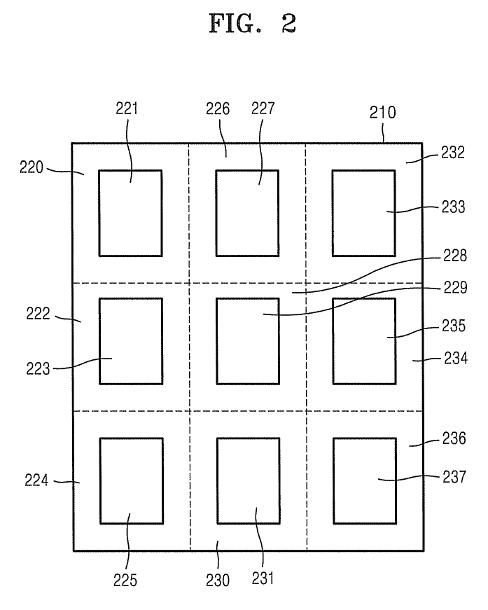

FIG. 2 is a diagram of printer paper 210, cells 220, 222, 224, 226, 228, 230, 232, 234, and 236, image items 221, 223, 225, 227, 229, 231, 233, 235, and 237 according to an aspect of the invention. That is, the cells 220, 222, 224, 226, 228, 230, 232, 234, and 236 are a plurality of areas generated when the printer paper 210 is divided according to the numbers of rows and columns set by the matrix setting unit 120. Referring to FIG. 2, the matrix setting unit 120 sets each of the numbers of rows and columns to 3, and accordingly, in the printer paper 210, 9 cells 220, 222, 224, 226, 228, 230, 232, 234, and 236 are formed. Also, the image items 221, 223, 225, 227, 229, 231, 233, 235, and 237 are printed in the cells 220, 222, 224, 226, 228, 230, 232, 234, and 236, respectively.

The maximum image size calculation unit 128 displays the calculated maximum image size through the user interface unit 116.

The image size specifying unit 130 sets an image size for printing desired by the user among image size values equal to or less than the displayed maximum image size. To accomplish this, the image size specifying unit 130 displays a window to request setting of an image size desired to be printed through the user interface unit 116. Then, the user may set the desired image size through the user interface unit 116, or by manipulating keys disposed on the terminal. By doing so, the image size specifying unit 130 specifies an image size desired to be printed. Also, the image size specifying unit 130 provides information on the specified image size to the XHTML-Print extension data generation unit 140.

The image alignment type specifying unit 132 specifies an alignment type of an image indicated by the selected image data. More specifically, the image alignment type specifying unit 132 can specify on which part of the horizontal axis and the vertical axis the selected image data is to be printed. Here, on which part of the vertical axis the selected image data is to be printed may refer to whether the selected image data is printed on the right-hand side, in the center, or on the left-hand side of a cell. Likewise, on which part of the horizontal axis the selected image data is to be printed may refer to whether the selected image data is printed at the top, the center, or the bottom of a cell.

To accomplish this, the image alignment type specifying unit 132 displays a window to request specifying of the image alignment type through the user interface unit 116. Then, the user may specify the image alignment type through the user interface unit 116, or by manipulating keys disposed on the terminal. By doing so, the image alignment type specifying unit 132 specifies an alignment type. Also, the image alignment type specifying unit 132 provides information on the specified alignment type to the XHTML-Print extension data generation unit 140.

The XHTML-Print extension data generation unit 140 generates XHTML-Print extension data by using the paper size specified by the paper size specifying unit 114, the numbers of rows and columns set by the matrix setting unit 120, one or more image data items selected by the image data selection unit 124, the setting indicating whether the aspect ratio of the image is to be maintained during printing set by the aspect ratio maintenance setting unit 126, the image size specified by the image size specifying unit 130, and the image alignment type specified by the image alignment type specifying unit 132.

The XHTML-Print basic data storage unit 150 stores XHTML-Print basic data that is essentially included in XHTML-Print printing data. The XHTML-Print extension data generated in the XHTML-Print extension data generation unit 140 can be inserted into XHTML-Print basic data.

The XHTML-Print printing data generation unit 160 reads the XHTML-Print basic data stored in the XHTML-Print basic data storage unit 150, and by inserting the XHTML-Print extension data generated by the XHTML-Print extension data generation unit 140 into the read XHTML-Print basic data, generates XHTML-Print printing data.

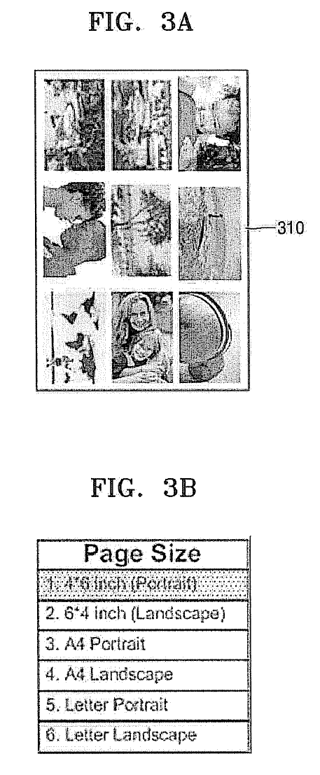

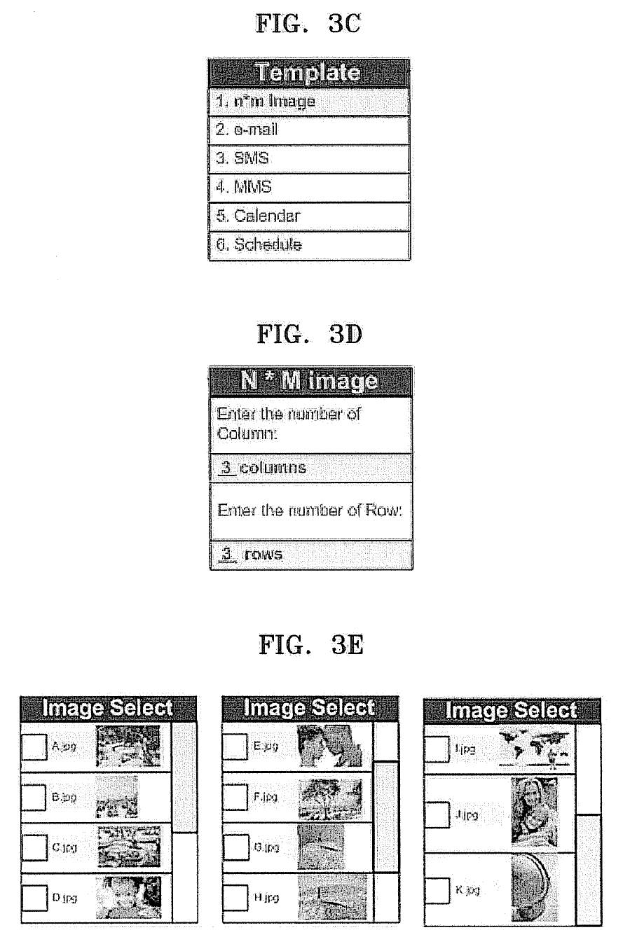

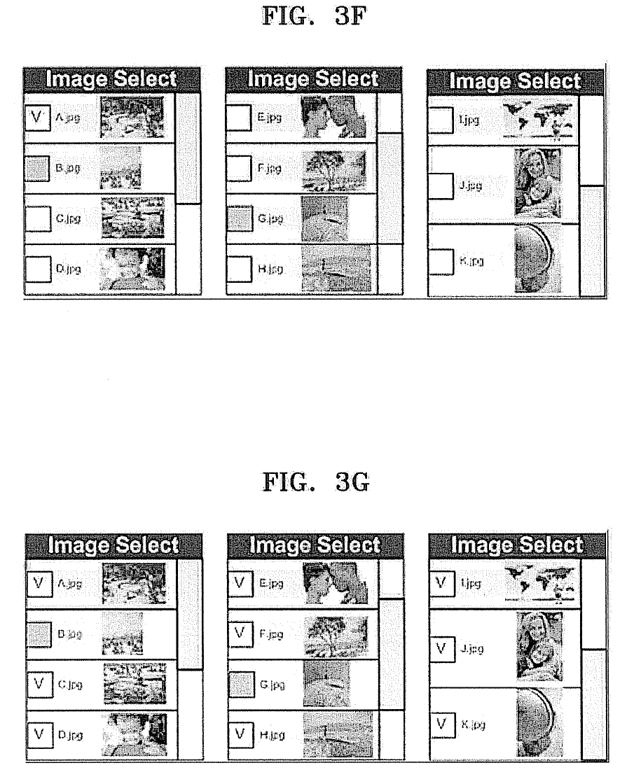

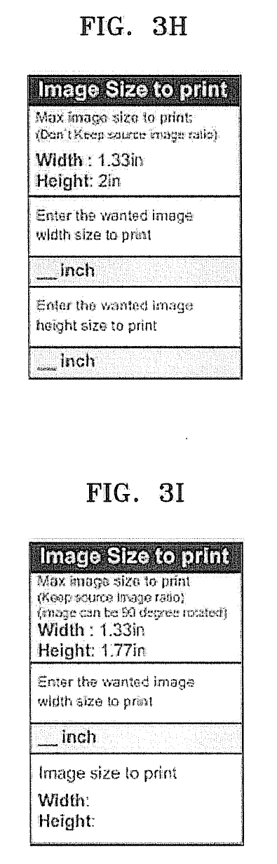

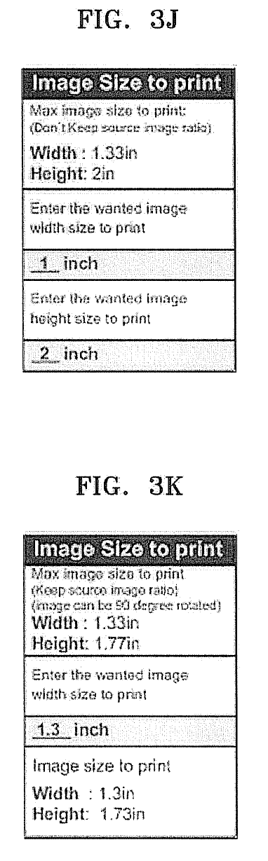

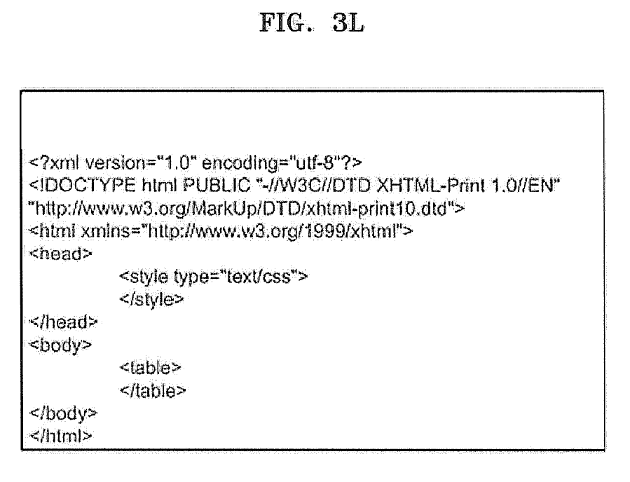

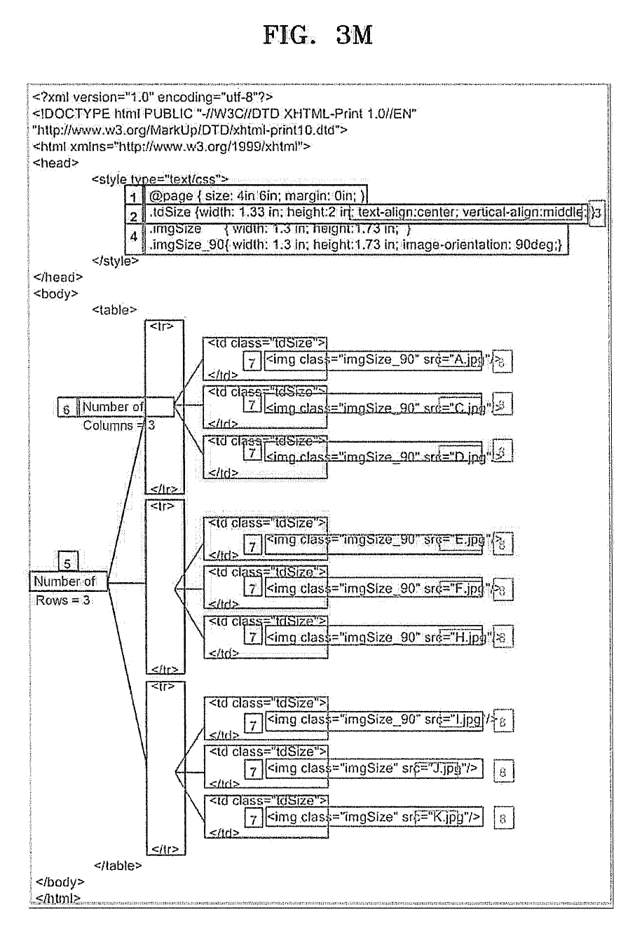

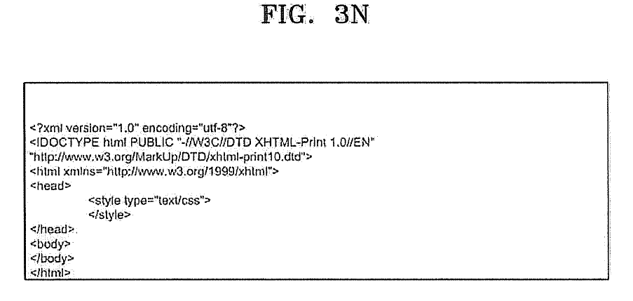

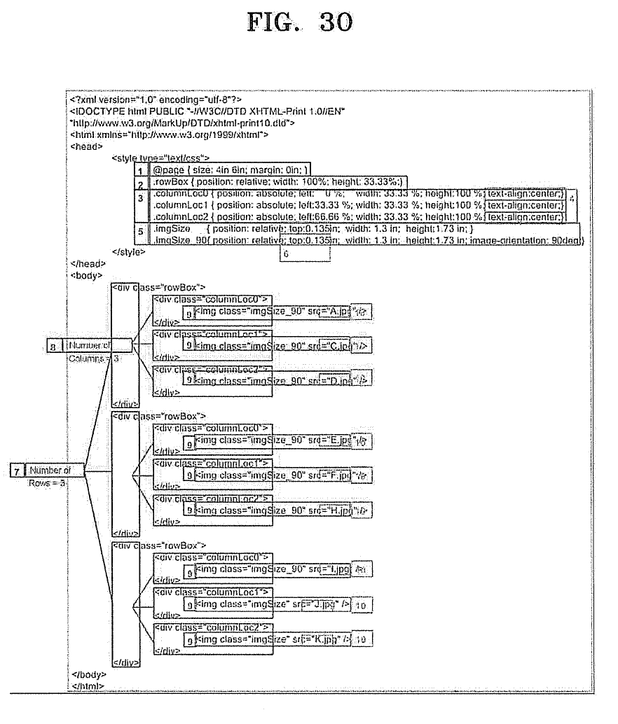

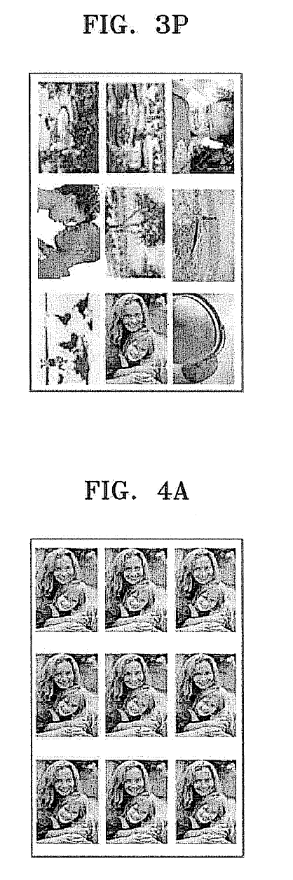

FIGS. 3A through 3P are figures for explaining a principle of generating XHTML-Print printing data according to an aspect of the invention.

According to this aspect of the invention, it is assumed that the user wants to print 9 different image data items among image data items stored in a terminal, in a 3*3 format using an image forming apparatus. FIG. 3A shows a printing result 310 desired by the user according to this aspect of the invention. The principle of generating XHTML-Print printing data according to this aspect of the invention will now be explained.

The user interface unit 116 displays a window as illustrated in FIG. 3B according to an instruction of the paper size specifying unit 114. Referring to FIG. 3B, the XHTML-Print printing data may be printed on 4*6 inch (portrait), 6*4 inch (landscape), A4 portrait, A4 landscape, letter portrait, or letter landscape size printer paper. However, the invention is not limited to these paper sizes, and any paper size and any combination of paper sizes may be used.

If the paper size specifying unit 114 specifies printing of XHTML-Print printing data on 6*4 landscape size printer paper without a margin, the XHTML-Print extension data generation unit 140 generates XHTML-Print extension data as @page {size: 6 in 4 in; margin: 0 in;}.

Likewise, if the paper size specifying unit 114 specifies printing of XHTML-Print printing data on A4 portrait size printer paper without a margin, the XHTML-Print extension data generation unit 140 generates XHTML-Print extension data as @page {size: A4 portrait; margin: 0 in;}.

Similarly, if the paper size specifying unit 114 specifies printing of XHTML-Print printing data on A4 landscape size printer paper without a margin, the XHTML-Print extension data generation unit 140 generates XHTML-Print extension data as @page {size: A4 landscape; margin: 0 in;}.

Also, if the paper size specifying unit 114 specifies printing of XHTML-Print printing data on letter portrait size printer paper without a margin, the XHTML-Print extension data generation unit 140 generates XHTML-Print extension data as @page {size: letter portrait; margin: 0 in;}.

Similarly, if the paper size specifying unit 114 specifies printing of XHTML-Print printing data on letter landscape size paper without a margin, the XHTML-Print extension data generation unit 140 generates XHTML-Print extension data as @page {size: letter landscape; margin: 0 in;}.

However, as illustrated in FIG. 3B, since the paper size specifying unit 114 specifies printing of XHTML-Print printing data on 4*6 inch (portrait) size printer paper without a margin, the XHTML-Print extension data generation unit 140 generates XHTML-Print extension data as @page {size: 4 in 6 in; margin: 0 in;}.

The user interface unit 116 may display a window as illustrated in FIG. 3C to enable the user to select a template. Referring to FIG. 3C, the user wants to print n*m images in a matrix format.

In this case, the user interface unit 116 displays a window as illustrated in FIG. 3D according to an instruction from the matrix setting unit 120. That is, the window illustrated in FIG. 3D is a window to request setting of the numbers of rows and columns. As illustrated in FIG. 3D, the matrix setting unit 120 sets each of the numbers of rows and the number of columns to 3.

Also, according to an instruction from the image data selection unit 124, the user interface unit 116 displays 11 image data items, A.jpg, B.jpg, C.jpg, D.jpg, E.jpg, F.jpg, G.jpg, H.jpg, I.jpg, J.jpg, K.jpg, stored in the image data storage unit 122 as illustrated in FIG. 3E.

Then, the user selects 9 image data items sequentially. According to FIG. 3F, the first image data item selected by the image data selection unit 124 is A.jpg.

After A.jpg is selected, it is impossible to select image data items, such as B.jpg and G.jpg, having a different aspect ratio, i.e., a different height to width ratio, than the aspect ratio (4/3) of the selected A.jpg image in a case where the aspect ratio maintenance setting unit 126 is omitted in an XHTML-Print printing data setting unit according to an aspect of the invention. The image data items that cannot be selected may be distinguished from other image data items that can be selected, for example, by shading as illustrated in FIG. 3F.

FIG. 3G shows that the image data selection unit 124 has selected 9 image data items in all.

The maximum image size calculation unit 128 calculates a maximum image size. At this time, the maximum image size calculation unit 128 calculates the maximum image size by considering whether the aspect ratio maintenance setting unit 126 has set printing with or without maintaining the aspect ratio of 4/3.

That is, if the aspect ratio maintenance setting unit 126 sets printing without maintaining the aspect ratio of 4/3, the maximum image size calculated by the maximum image size calculation unit 128 becomes the size of a cell as illustrated in FIG. 3H. If the width and length of a printer paper on which the 9 image data items are to be printed are 4 inches and 6 inches, respectively, the maximum image size calculated by the maximum image calculation unit 128 becomes 4 inches/3 columns=1.33 inches in width, and 6 inches/3 rows=2 inches in length.

If the aspect ratio maintenance setting unit 126 sets printing while maintaining the aspect ratio of 4/3, the maximum image size calculated by the maximum image size calculation unit 128 may be less than the size of a cell as illustrated in FIG. 3I. If the width and length of a printer paper on which the 9 image data items are to be printed are 4 inches and 6 inches, respectively, the maximum image size calculated by the maximum image calculation unit 128 becomes 4 inches/3 columns=1.33 inches in width and 1.33 inches in width×aspect ratio of 4/3=1.77 inches in length.

Thus, the user who recognizes the maximum image size through the displayed maximum image size specifies a desired image size among image size values equal to or less than the displayed maximum image size. By doing so, the image size specifying unit 130 can specify a desired image size of a selected image data item. At this time, the image size specifying unit 130 may specify desired image sizes of the 9 image data items, respectively, or may specify only one desired image size. If the image size specifying unit 130 specifies only one desired image size, the specified image size becomes the image size for each of the remaining 8 image data items. If the aspect ratio maintenance setting unit 126 sets printing without maintaining the aspect ratio of 4/3, the image size specifying unit 130 may set the width to be 1 inch and the length to be 2 inches as illustrated in FIG. 3J. If the user does not specify a desired image size for printing, the image size specifying unit 130 may automatically specify the displayed maximum image size as a desired image size for printing.

If the aspect ratio maintenance setting unit 126 sets printing while maintaining the aspect ratio of 4/3, then if one of the width and length is specified, the other is automatically specified. Accordingly, only one of the width and length need be specified as illustrated in FIG. 3K.

FIG. 3L illustrates XHTML-Print basic data stored in the XHTML-Print basic data storage unit 150, and FIG. 3M illustrates XHTML-Print printing data that is XHTML-Print basic data in which XHTML-Print extension data has been inserted.

As illustrated in FIGS. 3L and 3M, the XHTML-Print basic data and XHTML-Print printing data can be generated by using a <table> tag.

The XHTML-Print extension data generated by using the paper size specified in the paper size specifying unit 114 is inserted in the XHTML-Print basic data as indicated by identifier 1 shown in FIG. 3M.

As indicated by identifier 2 shown in FIG. 3M, .tdSize {width 1.33 in; height: 2 in;} that is XHTML-Print extension data generated according to the cell size calculated by using the numbers of rows and columns set in the matrix setting unit 120, that is, generated according to the width and length of the cell, is inserted into the XHTML-Print basic data.

If the image alignment type specifying unit 132 specifies that the selected image is to be printed on the left in a cell, XHTML-Print extension data, text-align: left; is generated. Also, if the selected image is specified to be printed at the center on the horizontal axis in a cell, XHTML-Print extension data, text-align: center; is generated. In addition, if the selected image is specified to be printed on the right in a cell, XHTML-Print extension data, text-align: right; is generated.

Similarly, if the selected image is specified to be printed at the top in a cell, XHTML-Print extension data, vertical-align: top; is generated. Also, if the selected image is specified to be printed at the center on the vertical axis in a cell, XHTML-Print extension data, vertical-align: middle; is generated. In addition, if the selected image is specified to be printed at the bottom in a cell, XHTML-Print extension data, vertical-align: bottom; is generated.

The XHTML-Print extension data generated in the image alignment type specifying unit 132, for example, text-align: center; and vertical-align: middle; is inserted into the XHTML-Print basic data together with the XHTML-Print extension data indicated by identifier 2, as indicated by identifier 3 shown in FIG. 3M.

As indicated by identifier 4 shown in FIG. 3M, .imgSize {width: 1.3 in; height: 1.73 in;} that is XHTML-Print extension data generated by using the image size specified by the image size specifying unit 130 is inserted into the XHTML-Print basic data. Also, since the selected image data may be rotated by 90 degrees and then printed, XHTML-Print extension data, .imgSize_{—}90 {width: 1.3 in; height: 1.73 in; image-orientation: 90 deg;}, is also generated and inserted into the XHTML-Print basic data together with .imgSize {width: 1.3 in; height: 1.73 in;}

The XHTML-Print extension data generation unit 140 generates the same number of <tr>'s and </tr>'s as the number of rows set in the matrix setting unit 120, as indicated by identifier 5 shown in FIG. 3M. Likewise, the XHTML-Print extension data generation unit 140 generates the same number of <td class=“tdSize”>'s and </td>'s as the number of columns set in the matrix setting unit 120, as indicated by identifier 6 shown in FIG. 3M. As indicated by identifiers 7 and 8 shown in FIG. 3M, <img class= “imgSize_{—}90” src=“A.jpg”/>, <img class= “imgSize_{—}90” src=“C.jpg”/>, <img class= “imgsize_{—}90” src=“D.jpg”/>, <img class= “imgSize_{—}90” src=“E.jpg”/>, <img class= “imgsize_{—}90” src=“F.jpg”/>, <img class= “imgSize_{—}90” src=“H.jpg”/>, <img class= “imgSize_{—}90” src=“I.jpg”/>, <img class= “imgsize” src=“J.jpg”/>, <img class= “imgSize” src=“K.jpg”/> that is XHTML-Print extension data generated by using 9 image data items, ((A.jpg, 4/3), (C.jpg, 4/3), (D.jpg, 4/3), (E.jpg, 4/3), (F.jpg, 4/3), (H.jpg, 4/3), (I.jpg, 4/3), (J.jpg, 3/4), (K.jpg, 3/4)), selected in the image data selection unit 124, are inserted into the XHTML-Print basic data.

The reason why imgSize_{—}90 is specified for A.jpg, C.jpg, D.jpg, E.jpg, F.jpg, H.jpg, and I.jpg, unlike imgSize specified for J.jpg and K.jpg, is that image data is rotated by 90 degrees and then printed in the cases of A.jpg, C.jpg, D.jpg, E.jpg, F.jpg, H.jpg, and I.jpg, unlike in the cases of J.jpg and K.jpg in which image data is not rotated by 90 degrees and then printed.

FIG. 3N illustrates XHTML-Print basic data stored in the XHTML-Print basic data storage unit 150. FIG. 3O illustrates XHTML-Print printing data that is XHTML-Print basic data into which XHTML-Print extension data has been inserted. As illustrated in FIGS. 3N and 3O, the XHTML-Print basic data and the XHTML-Print printing data can be generated by using a <div> tag.

The XHTML-Print extension data generated by using the paper size specified in the paper size specifying unit 114 is inserted into the XHTML-print basic data as indicated by identifier 1 shown in FIG. 3O.

According to the number of rows set in the matrix setting unit 120, XHTML-Print extension data, .rowBox {position: relative; width: 100%; height: (100/the number of rows)%;}, is generated. Likewise, according to the number of columns, XHTML-Print extension data as follows is generated.

.columnLoc0 {position: absolute; left: 0%; width: (100/the number of columns)%; height: 100%}

.columnLoc1 {position: absolute; left: 33.33%; width: (100/the number of columns)%; height: 100%}

. . .

.columnLoc(the number of columns−1) {position: absolute; left: 66.66%; width: (100/the number of columns)%; height: 100%}

The XHTML-Print extension data generated according to the set numbers of rows and columns is inserted into the XHTML-Print basic data as indicated by identifiers 2 and 3 shown in FIG. 3O.

If the image alignment type specifying unit 132 specifies that the selected image is to be printed on the left in a cell, XHTML-Print extension data, text-align: left; is generated. Also, if the image alignment type specifying unit 132 specifies that the selected image is to be printed at the center on the horizontal axis in a cell, XHTML-Print extension data, text-align: center; is generated. In addition, if the image alignment type specifying unit 132 specifies that the selected image is to be printed on the right in a cell, XHTML-Print extension data, text-align: right; is generated. The XHTML-Print extension data is inserted into the XHTML-Print basic data together with XHTML-Print extension data indicated by identifier 3, as indicated by identifier 4 shown in FIG. 3O.

If the image alignment type specifying unit 132 specifies that the selected image is to be printed at the top in a cell, XHTML-Print extension data, top: 0 in; is generated. Also, if the image alignment type specifying unit 132 specifies that the selected image is to be printed at the center on the vertical axis in a cell, XHTML-Print extension data, top: (((the length of printer paper/the number of rows)−the length of the image)/2) in; is generated. In addition, if the image alignment type specifying unit 132 specifies that the selected image is to be printed at the bottom in a cell, XHTML-Print extension data, top: ((the length of printer paper/the number of rows)−the length of the image) in; is generated. The XHTML-Print extension data is inserted into the XHTML-Print basic data together with XHTML-Print extension data indicated by identifier 5, as indicated by identifier 6 shown in FIG. 3O.

As indicated by identifier 5 shown in FIG. 3O, .imgSize {position: relative; width: 1.3 in; height: 1.73 in;} that is XHTML-Print extension data generated by using the image size specified in the image size specifying unit 130 is inserted into the XHTML-Print basic data. Also, since the selected image data may be rotated by 90 degrees and then printed, XHTML-Print extension data, .imgSize_{—}90 {position: relative; width: 1.3 in; height: 1.73 in; image-orientation: 90 deg;}, is also generated and inserted into the XHTML-Print basic data together with .imgSize {position: relative; width: 1.3 in; height: 1.73 in;}

As indicated by identifier 7 shown in FIG. 3O, the XHTML-Print extension data generation unit 140 generates the same number of <div class=“rowBox”>'s and </div>'s as the number of rows set in the matrix setting unit 120. Likewise, as indicated by identifier 8 shown in FIG. 3O, the XHTML-Print extension data generation unit 140 generates the same number of <div class=>'s and </div>'s as the number of columns in each <div class=“rowBox”> and </div>, and applies div's style to “columnLoc0” through “columnLoc(the number of columns−1)”.

As indicated by identifiers 9 and 10 shown in FIG. 3O, XHTML-Print extension data items, <img class= “imgSize_{—}90” src=“A.jpg”/>, <img class= “imgsize_{—}90” src=“C.jpg”/>, <img class= “imgSize_{—}90” src=“D.jpg”/>, <img class= “imgSize_{—}90” src=“E.jpg”/>, <img class= “imgSize_{—}90” src=“F.jpg”/>, <img class= “imgSize_{—}90” src=“H.jpg”/>, <img class= “imgSize_{—}90” src=“I.jpg”/>, <img class= “imgsize” src=“J.jpg”/>, and <img class= “imgSize” src=“K.jpg”/>, generated by using the 9 image data items, ((A.jpg, 4/3), (C.jpg, 4/3), (D.jpg, 4/3), (E.jpg, 4/3), (F.jpg, 4/3), (H.jpg, 4/3), (I.jpg, 4/3), (J.jpg, 3/4), (K.jpg, 3/4)), selected in the image data selection unit 124, are inserted into the XHTML-Print basic data.

The XHTML-Print printing data generated by the XHTML-Print printing data generation unit 160 is printed as the printing result 310 originally desired by the user as illustrated in FIG. 3A, as illustrated in FIG. 3P.

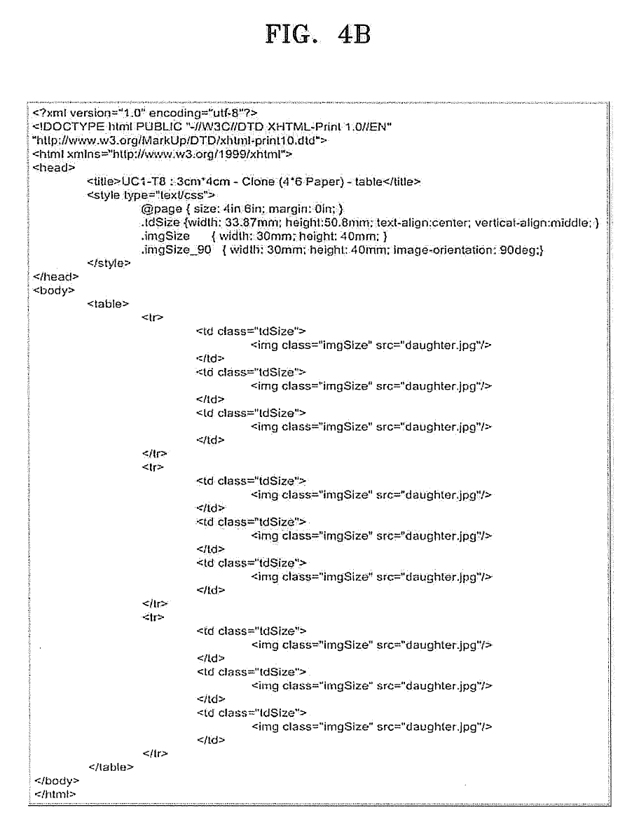

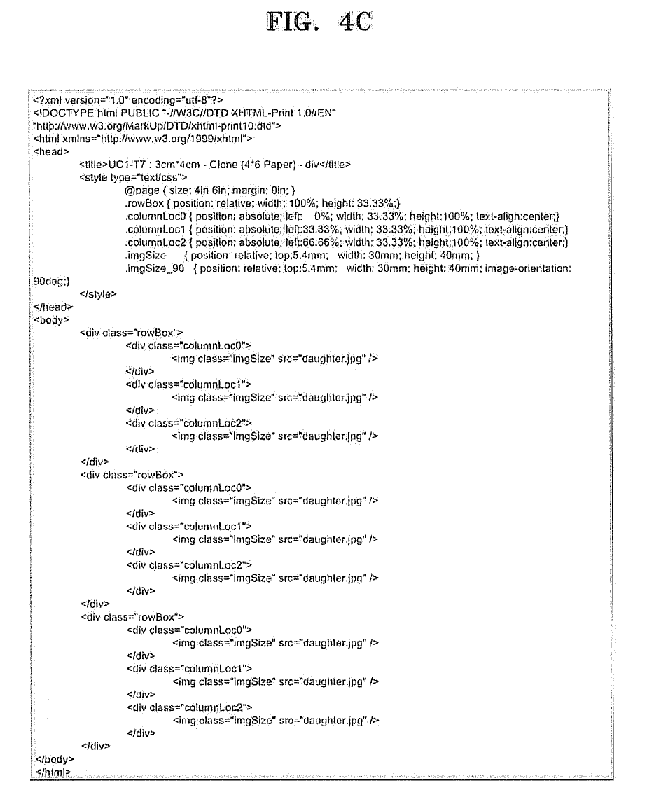

FIGS. 4A through 4C are figures for explaining a principle of generating XHTML-Print printing data according to another aspect of the invention;

According to this aspect of the invention, the user wants to print one image data item (daughter.jpg) among image data items stored in a terminal in a 3*3 format using an image forming apparatus. FIG. 4A illustrates a printing result desired by the user according to this aspect of the invention.

FIG. 4B illustrates XHTML-Print printing data generated by using a <table> tag according to this aspect of the invention. Also, FIG. 4C illustrates XHTML-Print printing data generated by using a <div> tag according to this aspect of the invention.

Since the principle of generating the XHTML-Print printing data according to this aspect of the invention is the same as that of generating the XHTML-Print printing data according to the aspect of the invention described with reference to FIGS. 3A through 3P, the principle of generating the XHTML-Print printing data according to the aspect of the invention described with reference to FIGS. 3A through 3P can also be applied to this aspect of the invention.

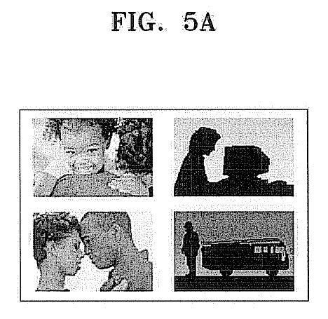

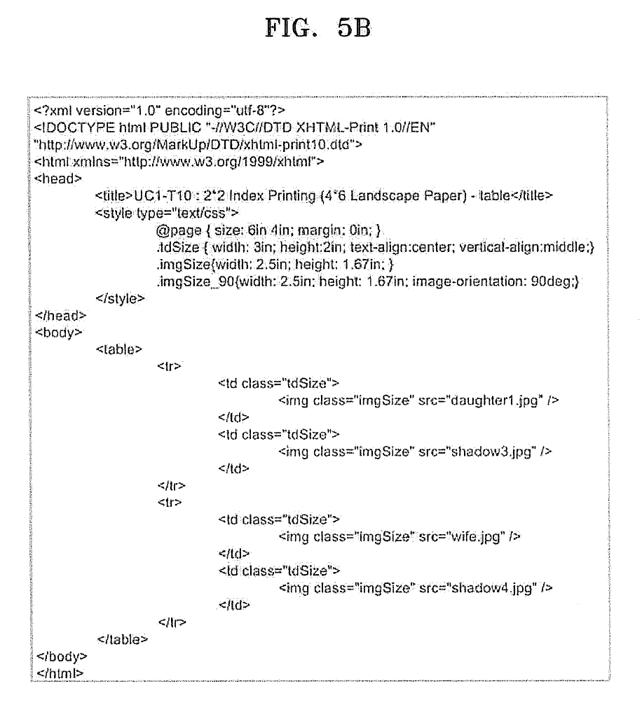

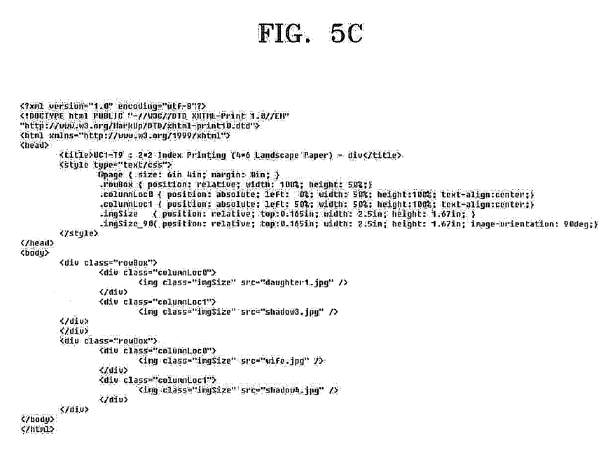

FIGS. 5A through 5C are figures for explaining a principle of generating XHTML-Print printing data according to another aspect of the invention.

According to this aspect of the invention, the user wants to print four image data items (daughter1.jpg, shadow3.jpg, wife.jpg, shadow4.jpg) among image data items stored in a terminal in a 4*4 format using an image forming apparatus. FIG. 5A illustrates a printing result desired by the user according to this aspect of the invention.

FIG. 5B illustrates XHTML-Print printing data generated by using a <table> tag according to this aspect of the invention. Also, FIG. 5C illustrates XHTML-Print printing data generated by using a <div> tag according to this aspect of the invention.

Since the principle of generating the XHTML-Print printing data according to this aspect of the invention is the same as that of generating the XHTML-Print printing data according to the aspect of the invention described with reference to FIGS. 3A through 3P, the principle according to the aspect of the invention described with reference to FIGS. 3A through 3P can also be applied to this aspect of the invention.

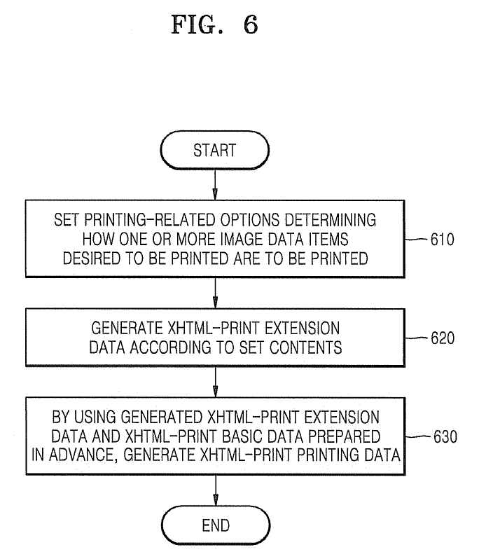

FIG. 6 is a flowchart of a method of generating XHTML-Print printing data according to an aspect of the invention. The method includes operations 610 through 630 for setting printing-related options by a user, generating XHTML-Print extension data corresponding to the contents set by the user, inserting the generated XHTML-Print extension data into XHTML-Print basic data prepared in advance, and by doing so, generating XHTML-Print printing data according to the intention of the user.

The XHTML-Print printing data setting unit 110 sets printing-related options to determine how to print one or more image data items desired to be printed in operation 610.

The XHTML-Print extension data generation unit 140 generates XHTML-Print extension data according to the contents set in operation 610 in operation 620.

The XHTML-Print printing data generation unit 160 inserts the XHTML-Print extension data generated in operation 620 into XHTML-Print basic data prepared in advance and generates XHTML-Print printing data in operation 630.

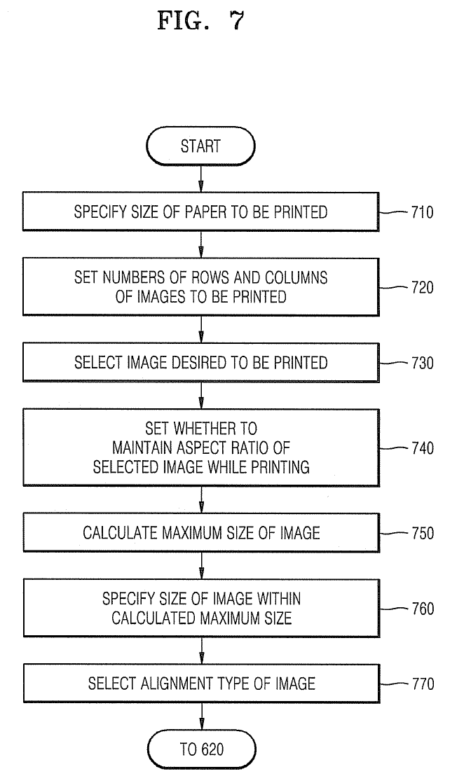

FIG. 7 is a detailed flowchart of operation 610 of FIG. 6 according to an aspect of the invention, and includes operations 710 through 770 for setting printing-related options.

In operation 710, the size of printer paper on which desired image data is to be printed is specified. In operation 720, the numbers of rows and columns of images to be printed are set. In operation 730, one or more image data items desired to be printed among one or more image data items prepared in advance are selected.

In operation 740, whether to maintain the aspect ratio of the image data selected in operation 730 when printing is performed is set. In operation 750, a maximum image size is calculated.

In operation 760, a desired image size is specified among image size values equal to or less than the maximum image size calculated in operation 750. In operation 770, the image alignment type of images indicated by the image data items selected in operation 730 is specified, and then operation 620 in FIG. 6 is performed.

Alternatively, operations 740 through 770 may be omitted from a method of generating XHTML-Print printing data according to another aspect of the invention.

Aspects of the invention can also be embodied as a computer-readable medium encoded with processing instructions for implementing a method of generating XHTML-Print printing data according to aspects of the invention performed by a computer. The computer-readable medium may be any data storage device that can store data which can be thereafter read by a computer, such as read-only memory (ROM), random-access memory (RAM), CD-ROMs, magnetic tapes, floppy disks, and optical data storage devices. Also, aspects of the invention may be embodied in computer-readable code embodied as a computer data signal in a carrier wave, or as data transmitted over a network, such as the Internet. The computer-readable medium can also be distributed over network-coupled computer systems so that the computer-readable code is stored and executed in a distributed fashion.

According to a method and apparatus for generating XHTML-Print printing data according to an aspect of the invention, XHTML-Print extension data is generated according to contents set by the user, and inserted into XHTML-Print basic data prepared in advance such that XHTML-Print printing data can be generated according to the intention of the user. Accordingly, a variety of XHTML-Print printing data items can always be easily generated. As a result, a terminal in which a method of generating XHTML-Print printing data according to an aspect of the invention is performed does not need to have many resources like a personal computer.

Although several embodiments of the invention have been shown and described, it would be appreciated by those skilled in the art that changes may be made in these embodiments without departing from the principles and spirit of the invention, the scope of which is defined in the claims and their equivalents.

What is claimed is:

1. A method of generating extensible hypertext markup language (XHTML) data comprising:
setting printing-related options in relation to one or more image data items desired to be printed;
generating XHTML extension data to be inserted into XHTML basic data prepared in advance according to the set printing-related options; and
generating XHTML printing data by inserting the XHTML extension data into the XHTML basic data.

2. The method of claim 1, wherein the setting of the printing-related options comprises selecting one or more image data items desired to be printed among one or more image data items prepared in advance.

3. The method of claim 2, wherein the setting of the printing-related options further comprises:
specifying a size of printer paper on which the selected one or more image data items are to be printed;
setting a number of images desired to be printed on the printer paper; and
setting a desired image size for printing of the selected one or more image data items.

4. The method of claim 3, wherein the setting of the printing-related options further comprises setting whether to maintain an aspect ratio of an image indicated by the selected one or more image data items when printing is performed before the setting of the desired image size for printing of the selected one or more image data items.

5. The method of claim 3, wherein the setting of the printing-related options further comprises specifying an alignment type of the selected one or more image data items.

6. The method of claim 3, wherein the setting of the number of images comprises setting a number of rows and a number of columns of images desired to be printed on the printer paper.

7. The method of claim 2, wherein the selecting of one or more image data items comprises:
displaying the one or more image data items prepared in advance; and
selecting the one or more image data items desired to be printed among the displayed one or more image data items;
wherein the selecting of the image data items comprises making it impossible to select image data items having an aspect ratio that is different from an aspect ratio of an image indicated by one image data item that is selected first among the selected one or more image data items.

8. An apparatus for generating extensible hypertext markup language (XHTML) data comprising:
an XHTML printing data setting unit that sets printing-related options in relation to one or more image data items desired to be printed;
an XHTML basic data storage unit that stores XHTML basic data to be included in XHTML printing data;
an XHTML extension data generation unit that generates XHTML extension data to be inserted into the XHTML basic data according to the set printing-related options; and
an XHTML printing data generation unit that generates the XHTML printing data by reading the stored XHTML basic data from the XHTML basic data storage unit and inserting the XHTML extension data generated by the XHTML extension data generation unit into the read XHTML basic data.

9. The apparatus of claim 8, wherein the XHTML printing data setting unit comprises:
a paper size specifying unit that specifies a size of a printer paper on which the one or more image data items desired to be printed are to be printed;
a matrix setting unit that sets a number of images desired to be printed on the printer paper;
an image data selection unit that selects the one or more image data items desired to be printed among one or more image data items prepared in advance; and
an image size setting unit that sets a desired image size for printing of the selected one or more image data items.

10. The apparatus of claim 9, wherein the XHTML printing data setting unit further comprises an aspect ratio maintenance setting unit that sets whether to maintain the aspect ratio of an image indicated by the selected one or more image data items when printing is performed.

11. The apparatus of claim 9, wherein the XHTML printing data setting unit further comprises an image alignment type specifying unit that specifies an alignment type of the selected one or more image data items.

12. The apparatus of claim 9, wherein the matrix setting unit sets a number of rows and a number of columns of images desired to be printed on the printer paper.

13. A computer-readable medium encoded with processing instructions for implementing a method of generating extensible hypertext markup language (XHTML) data performed by a computer, the method comprising:
setting printing-related options in relation to one or more image data items desired to be printed;
generating XHTML extension data to be inserted into XHTML basic data prepared in advance according to the set printing-related options; and
generating XHTML printing data by inserting the XHTML extension data into the XHTML basic data.

14. A method of generating extensible hypertext markup language (XHTML) data comprising:
setting at least one printing-related option specifying how at least one image data item is to be printed;
generating XHTML extension data containing instructions on how to print the at least one image data item based on the set at least one printing-related option; and
generating XHTML printing data for printing the at least one image data item by inserting the XHTML extension data into XHTML basic data.

15. The method of claim 14, wherein the setting of the at least one printing-related option comprises specifying a paper size of paper on which the at least one image data item is to be printed.

16. The method of claim 15, wherein the specifying of the paper size comprises selecting the paper size based on stored paper size information about a plurality of different paper sizes.

17. The method of claim 14, wherein the setting of the at least one printing-related option comprises setting a number of image data items to be printed.

18. The method of claim 17, wherein the setting of the number of image data items to be printed comprises setting a number of rows and a number of columns in which the number of image data items are to be printed.

19. The method of claim 14, wherein the setting of the at least one printing-related option comprises selecting the at least one image data item from at least one stored image data item.

20. The method of claim 19, wherein the selecting of the at least one image data item comprises selecting a plurality of image data items from a plurality of stored image data items.

21. The method of claim 20, wherein the selecting of the plurality of image data items comprises prohibiting selecting image data items having two different aspect ratios.

22. The method of claim 21, wherein the prohibiting of selecting image data items having two different aspect ratios comprises prohibiting selecting an image data item having an aspect ratio that is different from an aspect ratio of one of the plurality of image data items that is selected first in the selecting of the plurality of image data items.

23. The method of claim 14, wherein the setting of the at least one printing-related option comprises setting whether an aspect ratio of the at least one image data item is to be maintained when the at least one image data item is printed.

24. The method of claim 14, wherein the setting of the at least one printing-related option comprises setting an image size at which at least one image data item is to be printed.

25. The method of claim 24, further comprising calculating a maximum image size at which the at least one image data item can be printed;
wherein the setting of the image size comprises setting the image size to be equal to or less than the maximum image size.

26. The method of claim 14, wherein the setting of the at least one printing-related option comprises specifying an image alignment type to be used in printing the at least one image data item.

27. The method of claim 26, wherein the specifying of the image alignment type comprises:
specifying a horizontal image alignment type selected from left, center, and right; and
specifying a vertical image alignment type selected from top, middle, and bottom.

28. The method of claim 14, wherein the basic XHTML data does not contain any instructions on how to print the at least one image data item.

29. An apparatus for generating extensible hypertext markup language (XHTML) data comprising:
a printing data setting unit that sets at least one printing-related option specifying how at least one image data item is to be printed;
an XHTML extension data generation unit that generates XHTML extension data containing instructions on how to print the at least one image data item based on the set at least one printing-related option; and
an XHTML printing data generation unit that generates XHTML printing data for printing the at least one image data item by inserting the XHTML extension data into XHTML basic data.

30. The apparatus of claim 29, wherein the printing data setting unit sets the at least one printing-related option in response to an input by a user of the apparatus.

31. The apparatus of claim 29, wherein the printing data setting unit comprises a paper size specifying unit that specifies a paper size of paper on which the at least one image data item is to be printed.

32. The apparatus of claim 31, further comprising a paper size information storage unit that stores paper size information about a plurality of different paper sizes;
wherein the paper size specifying unit specifies the paper size based on the paper size information stored in the paper size information storage unit.

33. The apparatus of claim 29, wherein the printing data setting unit comprises an image number setting unit that sets a number of image data items to be printed.

34. The apparatus of claim 33, wherein the image number setting unit comprises a matrix setting unit that sets a number of rows and a number of columns in which the number of image data items are to be printed.

35. The apparatus of claim 29, further comprising an image data storage unit that stores the at least one image data item;
wherein the printing data setting unit comprises an image data selection unit that selects the at least one image data item from the at least one image data item stored in the image data storage unit.

36. The apparatus of claim 35, wherein the image data selection unit selects the at least one image data item in response to an input by a user of the apparatus.

37. The apparatus of claim 35, wherein the image data storage unit stores a plurality of image data items; and
wherein the image data selection unit selects a plurality of image data items from the plurality of image data items stored in the image data storage unit.

38. The apparatus of claim 37, wherein the image data selection unit prohibits selecting image data items having two different aspect ratios.

39. The apparatus of claim 38, wherein the image data selection unit prohibits the selecting of image data items having two different aspect ratios by prohibiting selecting an image data item having an aspect ratio that is different from an aspect ratio of one of the plurality of image data items that is selected first by the image data selection unit.

40. The apparatus of claim 29, wherein the printing data setting unit comprises an aspect ratio maintenance setting unit that sets whether an aspect ratio of the at least one image data item is to be maintained when the at least one image data item is printed.

41. The apparatus of claim 29, wherein the printing data setting unit comprises an image size specifying unit that sets an image size at which at least one image data item is to be printed.

42. The apparatus of claim 41, wherein the image size specifying unit sets the image size in response to an input by a user of the apparatus.

43. The apparatus of claim 41, further comprising a maximum image size calculation unit that calculates a maximum image size at which the at least one image data item can be printed;
wherein the image size specifying unit sets the image size to be equal to or less than the maximum image size.

44. The apparatus of claim 29, wherein the printing data setting unit comprises an image alignment type specifying unit that specifies an image alignment type to be used in printing the at least one image data item.

45. The apparatus of claim 44, wherein the image alignment type specifying unit specifies:
a horizontal image alignment type selected from left, center, and right; and
specifying a vertical image alignment type selected from top, middle, and bottom.

46. The apparatus of claim 29, wherein the basic XHTML data does not contain any instructions on how to print the at least one image data item.
